(19) United States
(12) Patent Application Publication
(10) Pub. No.: US 2003/0026908 A1
(43) Pub. Date: Feb. 6, 2003

(54) Sandable, self-healable coating compositions and a process of using the same

(76) Inventors: Matthew Lane, Bowling Green, OH (US); Keith Starr, Delta, OH (US); Michael R. Carroll, Whitehouse, OH (US); Bradley Richards, Maumee, OH (US)

Correspondence Address: BASF CORPORATION, ANNE GERRY SABOURIN, 26701 TELEGRAPH ROAD, SOUTHFIELD, MI, 48034-2442, US

(21) Appl. No.: 10/134,061

(22) Filed: Apr. 26, 2002

Related U.S. Application Data
(60) Provisional application No. 60/287,141, filed on Apr. 30, 2001.

(51) Int. Cl. B05D 3/02

(52) U.S. Cl. 427/385.5

(57) ABSTRACT

The invention provides coating compositions which are simultaneously sandable and self-healable shortly after application to a substrate and without the use of thermal curing. Said compositions have a film-forming component (A) with a first acrylic polymer (ai) having a number average molecular weight of from 1500 to 3000, an equivalent weight of from 375 to 475, and a plurality of functional groups wherein at least 60 to 100% of the functional groups are secondary hydroxyl groups, a second acrylic polymer (aii) having a number average molecular weight of from 3500 to 5000, an equivalent weight of from 550 to 750, and a plurality of functional groups with at least 75 to 100% of the functional groups being primary hydroxyl groups as well as a crosslinking component (B) comprising at least one aliphatic isocyanate functional trimer (bi), and at least one cycloaliphatic isocyanate functional trimer (bii).

### BACKGROUND OF THE INVENTION

(1.) FIELD OF THE INVENTION

The invention relates to coating compositions that are curable at ambient temperature and form urethane linkages. More particularly, the invention relates to two-component solventborne coating compositions intended for automotive refinish operations.

(2.) BACKGROUND ART

Automotive finishes must provide an esthetically appealing appearance while simultaneously meeting and maintaining rigorous performance and durability requirements. Automotive coating compositions may be applied by the original equipment manufacturer (OEM) or by automotive refinishers for repair purposes. Refinish operations may involve the repair of one or more outer coating layers, the repair or replacement of entire automotive body components, or a combination of both.

Automotive refinish coatings must meet all of the performance parameters required of OEM coatings but without benefit of the high temperature ovens and controlled application environments available in OEM facilities. For example, automotive refinish coatings must exhibit exceptional gloss, depth of color, and distinctness of image (DOI). They must also have high levels of adhesion, scratch and mar resistance, chip resistance, humidity resistance, and weatherability as measured by QUV and the like.

Because of the challenges inherent in the refinish application environment, it is often necessary to perform one or more finishing operations on a previously applied coating prior to its final curing. For example, refinish coatings, especially clearcoats, are typically “cut and buffed” after the coating is applied but before the coating is completely cured. Cutting refers to the use of light sanding to remove surface defects and/or imperfections resulting from dirt, too thick film builds, scratches, mars, and the like. Buffing refers to either hand or machine polishing used to improve the appearance of an applied coating composition. Buffing can be used to remove sanding marks, scratches, fingerprints, and the like and/or to improve the gloss and smoothness of an applied coating.

With prior art refinish compositions, it has been necessary to delay cutting and buffing until the applied coating has reached a certain degree of cure. Premature cutting and buffing results in the gumming up of the sandpaper and irreversible damage to the curing film. In such cases, it is necessary to wait until the coating completely cures so that it can be completely removed by heavy sanding. Prior art refinish coating compositions that are ‘fingerprintable’ are believed by those of skill in the art to be too “soft” to sand.

A “sandable” applied coating is one which will produce “dust” or “powder” upon machine sanding with a 1500 grit sandpaper and normally applied pressure. Typical prior art two-component ambient cure refinish compositions generally require a waiting period of at least twelve hours prior to sanding. Even thermally cured refinish coatings, i.e., those requiring at least 30 minutes at a minimum of 140 degrees F, need a waiting period of at least 1 1/2 to 2 hours prior to sanding.

Moreover, many prior art coatings take many hours or even days to achieve a degree of final cure such that the applied coating is not fingerprintable. “Fingerprintable” as used herein refers to the mark left by a thumb pressing down upon a coated surface with pressure sufficient to cause a reading of between 95 to 105 grams on a scale. Applied coatings that are fingerprintable may not be stacked, packaged or released to a customer. Thus, fingerprintable coatings are vulnerable to the imposition of many surface defects and imperfections.

It would be advantageous to provide a refinish coating composition that is self-healable during the period of time that it is fingerprintable. Such a coating composition would result in fewer surface defects and decreased finishing time.

It would also be highly advantageous to minimize the time required to achieve a sandable coating and/or a non-fingerprintable applied coating.

Automotive refinish operations continually seek to minimize the total time required for the application, cutting/buffing, and final cure of automotive refinish coatings. A delay in any one of these steps reduces the number of units that can be processed in a given unit of time and/or floor space. Thus, the total processing time is a critical parameter that affects the overall efficiency and profitability of an automotive refinish operation.

It would initially appear that cutting/buffing delays and final cure delays could be decreased with the use of highly catalyzed and/or rapidly reacting coating compositions. However, it has been found that such coatings generally lack the flow characteristics required to obtain finished films having the requisite degree of gloss, DOI and/or smoothness.

Accordingly, it is an object of this invention to provide an ambient cured coating composition that is suitable for use in automotive refinishing operations and is ready for finishing steps such as cutting and buffing shortly after application.

It is another object of the invention to provide an ambient cured coating composition that is self-healable during the time that it is fingerprintable.

It is a further object of the invention to provide an ambient cured coating composition that becomes non-fingerprintable more quickly than prior art coating compositions.

It is another object of the invention to provide an ambient cured automotive refinish coating composition that is ready for cutting and buffing shortly after application, is self-healable during the time that it is fingerprintable, becomes non-fingerprintable more quickly than prior art refinish coating compositions, and provides the performance and appearance parameters required of commercially acceptable refinish coatings, especially refinish clearcoats.

### BRIEF SUMMARY OF THE INVETION

These and other objects of the invention have unexpectedly been met with the composition and method of the invention.

The invention provides a coating composition that is suitable for automotive refinish operations, especially for use as an automotive refinish clearcoat composition. The coating compositions of the invention may be sanded and buffed at time when the applied composition is fingerprintable and has a pendulum hardness value of no more than 15. The applied coating composition also exhibits improvements in self-healing when fingerprintable. Finally, the applied coating composition becomes non-fingerprintable sooner than prior art coating compositions.

The coating composition of the invention comprises a film-forming component (A) having two or more active hydrogen containing components (a) and a crosslinking component (B) comprising two or more isocyanate functional components (b).

The two or more components (a) comprise a first acrylic polymer (ai) having a number average molecular weight of from 1500 to 3000, an equivalent weight of from 375 to 475, and a plurality of functional groups wherein at least 60 to 100% of the functional groups are secondary hydroxyl groups, and a second acrylic polymer (aii) having a number average molecular weight of from 3500 to 5000, an equivalent weight of from 550 to 750, and a plurality of functional groups wherein at least 75 to 100% of the functional groups are primary hydroxyl groups.

The two or more components (b) comprise at least one aliphatic isocyanate functional trimer (bi) and at least one cycloaliphatic isocyanate functional trimer (bii).

While not wishing to be bound by a particular theory, it is believed that it is the combination of components (ai), (aii), (bi) and (bii) that results in the unexpected properties with regards to self-healing and rapid sandability while ‘soft’.

The invention further provides a process of making a cured finished coated substrate comprising applying a coating composition to a substrate, curing said coating composition to provide ae ocoated surfae which is fingerprintable and has a pendulum hardness value of no more than 15, performing one or more finishing steps upon said processable coated surface to provide a finished coated surface, and curing said finished coated surface for a period of no more than 30 hours at ambient temperature to provide a cured finished coated surface having a pendulum hardness value of at least 32 and which is not fingerprintable.

In a most preferred embodiment of the invention, the applied coating composition will be the coating composition of the invention.

### DETAILED DESCRIPTION OF THE INVENTION

The coating compositions of the invention will generally be solvent borne, low VOC, high solids, two-component compositions.

The coating compositions of the invention will most preferably have a % nonvolatile (%NV) of at least 30%, preferably in the range of from 35 to 85 percent and more preferably in the range of from 40 to 65 percent, all in weight percentages based on the total weight of the composition. It will preferably have less than 0.6 kilograms of organic solvent per liter (5 pounds per gallon) of the composition, as determined per ASTM D3960.

“Two-component” as used herein refers to thermoset coating compositions having two or more components that are stored in separate containers until just prior to use. Mixing of the two or more components provides a curable coating composition that will have a pot life of anywhere from a few minutes to several hours. A pot life of greater than 30 minutes is generally acceptable, with a pot life of greater than 45 minutes being preferred, with a pot life of greater than or equal to 60 minutes being most preferred.

The coating composition of the invention comprises a film-forming component (A) having two or more active hydrogen containing components (a) and a crosslinking component (B) comprising two or more isocyanate functional components (b).

Film-forming component (A) will generally be present in the composition in an amount of from 40 to 80%, more preferably from 50 to 75%, and most preferably from 60 to 70%, all based on the % NV of component (A) and component (B). Component (B) will generally be present in the composition in an amount of from 20 to 60%, more preferably from 25 to 50%, and most preferably from 30 to 40%, all based on the % NV of component (A) and component (B).

While not wishing to be bound by a particular theory, it is believed that it is the combination of components (ai), (aii), (bi) and (bii) that results in the unexpected properties with regards to self-healing and rapid sandability while ‘soft’. Accordingly, in a most preferred embodiment, each of components (ai), (aii), (bi) and (bii) will be present, such that components (ai) and (aii) may not be satisfied by the presence of a single active hydrogen containing polymer (a). Similarly, components (bi) and (bii) most preferably will not be satisfied by the presence of a single isocyanate functional component (b).

The two or more components (a) comprise a first acrylic polymer (ai) having a number average molecular weight of from 1500 to 3000, an equivalent weight of from 375 to 475, and a plurality of functional groups wherein at least 60 to 100% of the functional groups are secondary hydroxyl groups, and a second acrylic polymer (aii) having a number average molecular weight of from 3500 to 5000, an equivalent weight of from 550 to 750, and a plurality of functional groups wherein at least 75 to 100% of the functional groups are primary hydroxyl groups. As used herein, “molecular weight” refers to number average molecular weight, which may be determined by the GPC method using a polystyrene standard.

The acrylic polymers (ai) and (aii) may be prepared from ethylenically unsaturated monomers. Suitable ethylenically unsaturated monomers are vinyl esters, vinyl ethers, vinyl ketones, aromatic or heterocyclic aliphatic vinyl compounds, and alkyl esters having more than 4 carbon atoms of alpha,beta-ethylenically unsaturated mono- or dicarboxylic acids containing 3 to 5 carbons. Preferred are the aromatic or heterocyclic aliphatic vinyl compounds and the C4 or greater alkyl esters of alpha, beta-unsaturated monocarboxylic acids such as acrylic or methacrylic acid.

Representative examples of suitable esters of acrylic, methacrylic, and crotonic acids include, without limitation, those esters from reaction with saturated aliphatic and cycloaliphatic alcohols containing from 4 to 20 carbon atoms, such as n-butyl, isobutyl, tert-butyl, isobornyl, 2-ethylhexyl, lauryl, stearyl, cycolhexyl, trimethylcyclohexyl, tetrahydrofuriyl, stearyl, and the like. Preferred are alkyl esters of from 2 to 12 carbon atoms, with alkyl esters of from 2 to 10 carbon atoms being most preferred. Methyl methacrylate, butyl methacrylate and butyl acrylate are most preferred.

Representative examples of aromatic or heterocylic aliphatic vinyl compounds include, without limitation, such compounds as styrene, alpha-methyl styrene, vinyl toluene, tert-butyl styrene, and 2-vinyl pyrrolidone. Styrene is a most preferred example.

Also suitable for use in preparing polymers (ai) and (aii) are ethylenically unsaturated monomers having functional groups such as hydroxyl, carbamate, and amide, with hydroxyl functional ethylenically unsaturated monomers being most preferred. Illustrative examples of suitable hydroxyl functional ethylenically unsaturated monomers are hydroxyalkyl acrylates and methacrylates such as hydroxy ethyl acrylate, hydroxyethyl methacrylate, hydroxybutyl acrylate, hydroxypropyl methacrylate, and the like. Hydroxyethyl methacrylate and hydroxypropyl methacrylate are especially preferred.

Useful ethylenically unsaturated acids include alpha,beta-olefinically unsaturated monocarboxylic acids containing 3 to 5 carbon atoms, alpha,beta-olefinically unsaturated dicarboxylic acids containing 4 to 6 carbon atoms and their anhydrides, unsaturated sulfonic acids, and unsaturated phosphonic acids. Representative examples include, without limitation, acrylic acid, methacrylic acid, crotonic acid, fumaric acid, maleic acid, itaconic acid and their respective anhydrides. Acrylic and methacrylic acid are most preferred.

Both first acrylic polymer (ai) and second polymer (aii) will preferably be prepared using from 10 to 90% of ethylenically unsaturated alkyl esters, from 10 to 65% of hydroxy functional ethylenically unsaturated monomers, from 1 to 40% of aromatic vinyl monomers, and from 0 to less than 5% of acid functional ethylenically unsaturated monomers, all based on the total weight of the monomers used to polymerize said individual polymer. More preferably, first acrylic polymer (ai) will be prepared using from 20 to 80% of ethylenically unsaturated alkyl esters, from 15 to 50% of hydroxy functional ethylenically unsaturated monomers, from 10 to 30% of aromatic vinyl monomers, and from 0 to less than 3% of acid functional ethylenically unsaturated monomers, all based on the total weight of the monomers used to polymerize said first polymer (ai). More preferably, second acrylic polymer (aii) will be prepared using from 30 to 90% of ethylenically unsaturated alkyl esters, from 10 to 40% of hydroxy functional ethylenically unsaturated monomers, from 10 to 3 5% of aromatic vinyl monomers, and from 0 to less than 1% of acid functional ethylenically unsaturated monomers, all based on the total weight of the monomers used to polymerize said second polymer (aii).

First acrylic polymer (ai) will have a number average molecular weight of from 1500 to 3000, more preferably from 1700 to 2800, and most preferably from 1900 to 2500. It will further have an equivalent weight of from 375 to 475, more preferably from 400 to 450, and most preferably an equivalent weight of from 410 to 440. It will be appreciated that the equivalent weight of first polymer (ai) is based on the plurality of functional groups of first polymer (ai).

It is an aspect of the invention that at least 60 to 100% of the plurality of functional groups of first polymer (ai) be secondary hydroxyl groups, more preferably from 70 to 90%, and most preferably from 75 to 85%, based on the total number of functional groups. In a most preferred embodiment of the invention, first polymer (ai) have no more than 40% of primary hydroxyl groups, and most preferably no more than 25% of primary hydroxyl groups, based on the total number of functional groups.

Second acrylic polymer (aii) will have a number average molecular weight of from 3500 to 5000, more preferably from 3750 to 4600, and most preferably from 3800 to 4400. It will further have an equivalent weight of from 550 to 750, more preferably from 600 to 700, and most preferably an equivalent weight of from 615 to 690. It will be appreciated that the equivalent weight of second polymer (aii) is based on the plurality of functional groups of second polymer (aii).

It is an aspect of the invention that at least 75 to 100% of the plurality of functional groups of second polymer (aii) be primary hydroxyl groups, more preferably from 80 to 100, and most preferably from 90 to 100, based on the total number of functional groups. In a most preferred embodiment of the invention, second polymer (aii) will have no more 25% of secondary hydroxyl groups, and most preferably no more than 10% of secondary hydroxyl groups, based on the total number of functional groups of second polymer (aii).

First and second acrylic polymers (ai) and (aii) will generally be present in a ratio such that the first acrylic polymer (ai) will present in an amount of from 40 to 70%, more preferably 45 to 65% , and most preferably from 50 to 60%, based on the total %NV of the film-forming component (A).

It will be appreciated that film-forming component (A) may be further comprised of other polymers and/or oligomeric components. Suitable examples include other acrylics, modified acrylics, polyesters, polyurethanes, mixtures thereof, and the like. In a most preferred embodiment of the invention, film-forming component (A) will consist of the above described acrylic polymers (ai) and (aii).

Crosslinking component (B) will be comprised of at least two isocyanate functional components (b).

Suitable isocyanate functional components (b) are those having at least two isocyanate groups. Crosslinking component (B) should be present in an amount relative to film-forming component (A) such that the ratio of equivalents of isocyanate from isocyanate functional components (b) per equivalent of hydroxyls from film-forming component (A) is inthe range of from 0.9/1 to 1.9/1, preferably in the range of from 1.1/1 to 1.6/1, more preferably in the range of from 1.2/1 to 1.4/1.

Suitable isocyanate functional components include the di-, tri-, and/or poly isocyanates of aromatic isocyanates, aliphatic isocyanates, cycloaliphatic isocyanates, and mixtures thereof. Illustrative examples of suitable isocyanates include diisocyanates such as 1,6-hexamethylene diisocyanate, isophorone diisocyanate, 4,4′-biphenylene diisocyanate, toluene diisocyanate, biscyclohexyl diisocyanate, tetramethylene xylene diisocyanate, ethyl ethylene diisocyanate, 1-methyltrimethylene diisocyanate, 1,3-phenylene diisocyanate, 1,5-napthalene diisocyanate, bis-(4-isocyanatocyclohexyl)-methane and 4,4′-diisocyanatodiphenyl ether. Also suitable for use as component (B) are the allophanate modifications of such isocyanate functional compounds.

While not wishing to be bound to a particular theory, it is believed that the unexpected result with respect to fingerprintable but sandable coated films may be attributable to the use of particular isocyanate functional components (bi) and (bii). In a most preferred embodiment, isocyanate functional component (b) will be comprised of at least one aliphatic isocyanate functional trimer (bi), and at least one cycloaliphatic isocyanate functional trimer (bii).

Suitable aliphatic isocyanate functional trimers are the trimers of 1,6-hexamethylene diisocyanate, ethyl ethylene diisocyanate, 1-methyltrimethylene diisocyanate, and the like. The trimers of allophanate modified isocyanates are also suitable for use herein. The trimer of 1,6-hexamethylene diisocyanate is most preferred for use as the at least one aliphatic isocyanate functional trimer (bi).

Suitable cycloaliphatic isocyanate functional trimers (bii) are the trimers of isophorone diisocyanate, biscyclohexyl diisocyanate, and the like. The trimers of allophanate modified isocyanates are also suitable for use herein. The trimer of isophorone diisocyanate is most preferred for use as the at least one cycloaliphatic isocyanate functional trimer (bii).

Trimer (bi) will most preferably be present in an amount of from 50 to 95, more preferablely from 60 to 90, and most preferably from 70 to 85, based on the total nonvolatile of crosslinking component (B). Trimer (bii) will most preferably be present in an amount of from 5 to 50, more preferablely from 10 to 40, and most preferably from 15 to 3 0, based on the total nonvolatile of crosslinking component (B).

In a most preferred embodiment, crosslinking component (B) will consist essentially of the above described isocyanate components (bi) and (bii) and other isocyanate functional components selected from the group consisting of isocyanate functional dimers. A most preferred isocyanate functional dimer is hexamethylene diisocyanate.

One or both of components (A) and/or (B) may contain an effective amount of a catalyst for accelerating the curing process. The effective amount depends upon the reactivity of the primary hydroxyl group of the reactive oligomer present in the hydroxyl component of the binder. Generally, in the range of about 0.001 percent to about 5 percent, preferably in the range of from 0.01 percent to 2 percent, more preferably in the range of from 0.02 percent to 1 percent, all in weight percent based on the total weight of binder solids of the catalyst is utilized. A wide variety of catalysts such as tin compounds and tertiary amines are suitable, however, tin catalysts are preferred. Suitable examples include dibutyl tin dilaurate and dibutyl tin diacetate. These catalysts can be used alone or in conjunction with carboxylic acids such as acetic acid or benzoic acid.

Optionally, either component (A) or a third component may further include in the range of from 0 to 30 weight %, based on the weight percentages based on the total nonvolatile weight of components (A), additional crosslinkers, such as aldimine oligomers and ketamine oligomers. Aldimine oligomers are the reaction product of alkyl aldehydes with diamines, i.e., isobutyraldehyde with isophorone diamine. Ketimine oligomers are the reaction product of alkyl ketones with diamines, i.e., methyl isobutyl ketone with 2-methyl pentamethylene diamine.

The coating composition of the invention will further contain at least one organic solvent which is typically selected from the group consisting of aromatic hydrocarbons, such as, petroleum naphtha or xylenes; ketones such as methyl amyl ketone, methyl isobutyl ketone, methyl ethyl ketone or acetone; esters such as butyl acetate or hexyl acetate; and glycol ether esters. such as propylene glycol monomethyl ether acetate. The amount of organic solvent added depends upon the desired solids level as well as the desired amount of VOC of the composition. If desired, the organic solvent may be added to both components of the binder.

The coating composition of the invention may also contain conventional additives, such as, pigments, stabilizers, rheology control agents, flow agents, toughening agents and fillers. Such additional additives will, of course, depend on the intended use of the coating composition. Fillers, pigments, and other additives that would adversely effect the clarity of the cured coating will not be included if the composition is intended as a clear coating. The foregoing additives may be added to either component of the two component coating composition of the invention.

The method of the invention may be practiced with a variety of substrates. Suitable substrates may be uncoated or coated, and may be selected from the group of metals, plastics, and mixtures thereof.

After application to the substrate in a film build of no more than 4 mils, preferably from 1.0 to 3.0 mils, most preferably from 1.8 to 2.5 mils, the coating will be cured at ambient temperature for a period of time sufficient for the applied coating to become a processable coated surface. “Ambient” as used herein refers to room or outdoor temperatures of from 68 to 120 degrees F, preferably from 72 to 100 degrees F and most preferably from 75 to 85 degrees F.

A processable coated surface as used herein refers to a coated surface which is fingerprintable and has a pendulum hardness value of no more than 15, more preferably from 7 to 12, and most preferably no less than 5. “Fingerprintable” as used herein refers to the mark left by a thumb pressing down upon a coated surface with pressure sufficient to cause a reading of between 95 to 105 grams on a scale.

Once the applied coating composition becomes a processable coated surface, one or more finishing steps may be performed upon said processable surface. Finishing steps may be defined as sanding, polishing, and mixtures thereof, with or without the assistance of sanding or polishing compounds. It will be appreciated that sanding is intended to be equivalent to “cutting”, while polishing is the same as “buffing”. Both sanding and polishing may be done by manually by hand or mechanically with a machine. Polishing may be wet or dry. While sanding operations may be conducted with a variety of sanding papers, those having a 1500 grit with normally applied pressure are most preferred.

The performance of one or more finishing steps upon the processable coated surface results in a finished-coated surface. Said finished-coated surface is then cured at ambient temperature for a time sufficient to provide a cured finished surface. It is an aspect of the invention that a sufficient time will be no more than 30 hours, preferably no more than 24 hours, more preferably no more than 18 hours and most preferably no more than 12 hours. A cured finished surface may be defined as one having as pendulum hardness value of at least 32 and which is not fingerprintable.

Pendulum hardness value refers to the hardness value obtained with a Konig Pendulum hardness tester in accordance with ASTM D4366-87, hereby incorporated by reference.

It is within the scope of the method of the invention that a variety of coating compositions may be suitable for use therein. However, in a most preferred embodiment of the invention, the coating composition to be applied will be the coating composition of the invention.

### EXAMPLE 1(a)

### Preparation of a First Acrylic resin (ai)

A first acrylic resin according to the invention was prepared by copolymerizing approximately 55 parts of a monomer composition (A) in approximately 22 parts methyl amyl ketone at 294° F. using approximately 4 parts of an initiator composition (B). The monomer composition (A) and the initiator composition (B) were introduced into a reactor uniformly and concurrently over a 4 hour period followed by three monomer conversion periods separated by two small additions of initiator and the final inclusion of about 19 parts of a solvent mixture(C), via various flushes and let-downs. Monomer composition (A) consisted of about 33% methyl methacrylate, 14% styrene, 34% hydroxypropyl methacrylate, 19% n-butyl methacrylate, and less than 1% methacrylic acid, based on the total monomer mixture. The initiator composition (B) had approximately 50% xylene and 50% t-butyl peroxybenzoate peroxide initiator, based on the total weight of the initiator composition. The solvent mixture (C) had approximately 95% methyl amyl ketone and about 5% xylene. The resulting acrylic resin had a number average molecular weight of about 2300 and an equivalent weight of about 426. Approximately 80% of the total hydroxyls were secondary hydroxyl groups.

### EXAMPLE 1 (b) Preparation of a Second Acrylic Resin (aii)

The procedure of Example 1(a) was followed except that monomer composition (A) in this case consisted of 47% methyl methacrylate, 17% styrene, 20% hydroxyethyl methacrylate, and 14% n-butyl methacrylate; and the solvent mixture (C) consisted of about 90% methyl amyl ketone and about 10% of xylene. The resulting acrylic polymer had a number average molecular weight of about 4100 and an equivalent weight of about 650. About 100% of the total functional groups were primary hydroxyl groups.

### EXAMPLE 2

### Preparation of Clearcoat Coating Compositions A, B, C, D, & E

Clearcoat formulations A, B, C, D, and E were prepared according to the formulations set forth in Table 1.

TABLE 1

| Components | A | B | C | D | E |
|---|---|---|---|---|---|
| CAB¹ | .27 | .51 | .50 | — | — |
| Acrylic Resin of | 14.94 | 28.45 | 27.27 | — | — |
| Example 1(a) | | | | | |
| Acrylic Resin of | 11.14 | — | — | 25.78 | 27.45 |
| Example 1(b) | | | | | |
| ethyl acetate | 2.21 | — | 2.71 | 1.72 | — |
| toluene | 2.76 | 3.84 | 3.57 | 2.73 | 3.00 |
| Xylene | 5.62 | 1.67 | 2.13 | 4.06 | 4.00 |
| EEP² | 3.63 | — | — | — | — |
| acetone | 10.80 | 3.93 | 3.77 | 16.25 | 17.30 |
| MIBK | 1.93 | — | — | 5.78 | 6.16 |
| MAK³ | 22.05 | 21.80 | 20.89 | 24.45 | 26.03 |
| n-butyl acetate | .89 | 11.30 | 4.71 | — | 2.26 |
| Solvesso ® 100 | 3.41 | 4.95 | 8.36 | 2.66 | — |
| butyl cellosolve | 2.56 | — | 3.30 | 2.00 | — |
| acetate | | | | | |
| benzotriazole | 1.14 | .82 | .79 | 1.18 | 1.26 |
| UVA⁴ | | | | | |
| silicone | 0.10 | .07 | .06 | .09 | .09 |
| additive | | | | | |
| benzoic acid | 0.15 | — | — | .04 | .04 |
| butyl benzyl | .53 | .74 | .71 | — | — |
| phthalate | | | | | |
| DBTDL | .06 | .06 | .05 | .05 | .05 |
| HALS⁵ | .74 | .55 | .52 | .59 | .63 |
| HDI trimer | — | 17.21 | — | — | 11.23 |
| HDI trimer | 10.07 | — | 12.33 | 7.83 | — |
| w/allophonation | | | | | |
| IPDI trimer | 3.08 | — | 3.77 | 2.39 | — |
| HDI dimer | 1.50 | — | 1.84 | 1.17 | — |

¹Cellulose Acetate Butyrate Resin
²Ethoxyethyl Propionate
³Methyl amyl ketone
⁴Ultraviolet light absorber
⁵Hindered amine light stabilizer

It will be appreciated that clearcoat A is within the scope of the invention while clearcoats B, C, D, and E represent the prior art.

### EXAMPLE 3

Clearcoat compositions A, B, C, D, and D were evaluated per the following tests: fingerprint & self-healing test (Table 2); gloss & pot life (Table 3);

pendulum hardness test (Table 4); and sanding test (Table 5).

TABLE 2
Fingerprint & Self-Healing Test

| | Time after application of clearcoat composition to steel panel | | | | | | | |
|---|---|---|---|---|---|---|---|---|
| Clearcoat | 30 min | 45 min | 60 min | 75 min | 90 min | 105 min | 120 min | 12 hrs |
| A | PS | PH | PH | PH | PH | PH | NP | NP |
| B | PS | PS | PS | PH | PH | PH | PH | NP |
| C | PS | PS | PS | PH | PH | PH | PH | NP |
| D | NP | NP | NP | NP | NP | NP | NP | NP |
| E | NP | NP | NP | NP | NP | NP | NP | NP |

PS = print stayed; PH = print healed; NP = no print/not fingerprintable.

Fingerprint and self healing was evaluated using a 2 mil draw down on cold rolled steel. The coated panel to be tested was placed on a scale and a thumb placed thereon with a downward pressure until the scale registered a weight of between 95 to 105 grams. Fingerprints were made 30 minutes, 45 minutes, 60 minutes, 75 minutes, 90 minutes, 105 minutes, 120 minutes, and 12 hours after the coating was applied to the cold rolled steel panel. Thus, each panel had eight fingerprints applied thereto. A fingerprint was said to be “healed” if it was not detectable by the naked eye appoximately 10 minutes after it was first made. Applied coatings which are fingerprintable, whether self-healing or not, have generally been perceived as not ready for sanding.

TABLE 3
Pot Life & Gloss

| | POT LIFE | | |
|---|---|---|---|
| | | Time (minutes) for | GLOSS |
| Clearcoats | Initial viscosity (sec) | viscosity to double | (%) |
| A | 14.0 | 90 | 89 |
| B | 21.9 | 60 | 84 |
| C | 17.0 | 120 | 84 |
| D | 14.0 | 30-45 | 52 |
| E | 14.0 | 30-45 | 59 |

Pot life was evaluated as the time required for the clearcoat compositions of Example 2 to double their intial viscosity. Viscosity was measured on a #4 Ford cup.

Gloss was evaluated on a 20 degrees glossmeter using the nonfingerprinted portions of the panels prepared for the fingerprint and self-healing test. A commercially acceptable clearcoat must have a gloss of at least 80%.

TABLE 4
Pendulum Hardness Test

| Clearcoat | 1.5 hours | 2 hours | 12 hours |
|---|---|---|---|
| A | 5 | 6 | 32 |
| B | too soft | 4 | 31 |
| C | too soft | 4 | 25 |
| D | 9 | 9 | 41 |
| E | 16 | 17 | 50 |

Pendulum hardness values were obtained with a Konig Pendulum hardness tester in accordance with ASTM D4366-87, hereby incorporated by reference. The higher the value, the harder the applied coating. The unit of time reflects the passage of time since the coating was applied to the substrate.

The clearcoat samples of Example 2 were drawn down on glass to a film build of approximately 2.0 mils. Applied coatings having a pendulum hardness value of less than 10 have generally been thought to be too soft for sanding.

TABLE 5
Sanding

| | | | | | | 105 | 120 |
|---|---|---|---|---|---|---|---|
| Clearcoat | 30 min | 45 min | 60 min | 75 min | 90 min | min | min |
| A | YES | YES | YES | YES | YES | YES | YES |
| B | NO | NO | NO | NO | YES | YES | YES |
| C | NO | NO | NO | NO | NO | NO | NO |
| D | YES | YES | YES | YES | YES | YES | YES |
| E | YES | YES | YES | YES | YES | YES | YES |

Sanding was performed with a Hutchins industrial speed sander using 3 M brand P1500 256L production resin bond free cut film sanding paper. A “no” means that the applied coating was too soft for sanding, i.e., gumming of the sandpaper and/or substantial damage to the applied film occurred. A “yes” was registered when a gum-free powder formed on the sand paper.

A review of Table 5 indicates that only clearcoats A, D and E are sandable less than 90 minutes after application. However, it can be seen from Table 3 that clearcoats D and E possess unacceptable gloss and much shorter pot lives relative to the other coatings. Finally, Tables 2, 4, and 5 illustrate that clearcoat A is sandable even though it is soft and fingerprintable.

Accordingly, it can be seen that the coating composition of the invention provides unexpected improvements in sandability, processing time, and/or appearance relative to the prior art coating compositions.

1. A coating composition comprising
(A) a film-forming component comprising
(a) two or more active hydrogen containing components comprising
(ai) a first acrylic polymer having a number average molecular weight of from 1500 to 3000, an equivalent weight of from 375 to 475, and a plurality of functional groups wherein at least 60 to 100% of the functional groups are secondary hydroxyl groups, and
(aii) a second acrylic polymer having a number average molecular weight of from 3500 to 5000, an equivalent weight of from 550 to 750, and a plurality of functional groups wherein at least 75 to 100% of the functional groups are primary hydroxyl groups, and
(B) a crosslinking component comprising
(b) two or more isocyanate functional components comprising
(bi) at least one aliphatic isocyanate functional trimer, and
(bii) at least one cycloaliphatic isocyanate functional trimer.

2. A process of making a cured finished coated substrate, comprising
applying a coating composition to a substrate,
curing said coating composition to provide a processable coated surface which is fingerprintable and has a pendulum hardness value of no more than 15,
performing one or more finishing steps upon said processable coated surface to provide a finished coated surface, and
curing said finished coated surface for a period of no more than 30 hours at ambient temperature to provide a cured finished coated surface having a pendulum hardness value of at least 32 and which is not fingerprintable.

3. A process of making a cured finished coated substrate, comprising applying a coating composition to a substrate, said coating composition comprising
(A) a film-forming component comprising
(a) two or more active hydrogen containing components comprising
(ai) a first acrylic polymer having a number average molecular weight of from 1500 to 3000, an equivalent weight of from 375 to 475, and a plurality of functional groups wherein at least 60 to 100% of the functional groups are secondary hydroxyl groups, and
(aii) a second acrylic polymer having a number average molecular weight of from 3500 to 5000, an equivalent weight of from 550 to 750, and a plurality of functional groups wherein at least 75 to 100% of the functional groups are primary hydroxyl groups, and
(B) a crosslinking component comprising
(b) two or more isocyanate functional components comprising
(bi) at least one aliphatic isocyanate functional trimer, and
(bii) at least one cycloaliphatic isocyanate functional trimer,
curing said coating composition to provide a processable coated surface which is fingerprintable and has a pendulum hardness value of no more than 15,
performing one or more finishing steps upon said processable coated surface to provide a finished coated surface, and
curing said finished coated surface for a period of no more than 30 hours at ambient temperature to provide a cured finished coated surface having a pendulum hardness value of at least 32 and which is not fingerprintable.
